(19) United States
(12) Patent Application Publication
(10) Pub. No.: US 2006/0272638 A1
(43) Pub. Date: Dec. 7, 2006

(54) Dosing device and method for dosing

(75) Inventors: Rolf-Stefan Brickl, Warthausen (DE); Juergen Schraivogel, Ummendorf/Fischbach (DE)

Correspondence Address: MICHAEL P. MORRIS;BOEHRINGER INGELHEIM CORPORATION, 900 RIDGEBURY ROAD, P. O. BOX 368, RIDGEFIELD, CT, 06877-0368, US

(73) Assignee: Boehringer Ingelhelm Intemational GmbH, Ingeiheim (DE)

(21) Appl. No.: 10/595,038

(22) PCT Filed: Jul. 6, 2004
(86) PCT No.: PCT/EP04/07363

§ 371 Date: Jun. 5, 2006

(30) Foreign Application Priority Data
Jul. 9, 2003 (DE) 103 31 029.0

(51) Int. Cl. B05D 7/14; B65D 83/06

(52) U.S. Cl. 128/203.15

(57) ABSTRACT

The invention relates to a dosing device for dosing small-particled pharmaceutical preparations, particularly preparations in the form of pellets, granules or extruded materials. The dosing device (10) shown has a chamber (16) for accommodating a larger amount of the preparation and a dosing element (22) on which is formed a dosing chamber (52), the volume of which corresponds to a defined partial quantity of the preparation, and which is movable between a filling position in which the dosing chamber (52) is to be filled with preparation from the chamber (16), and a release position in which the preparation from the dosing chamber (52) is to be dispensed from the dosing device (10). The volume of the dosing chamber (52) is adjustable for determining the defined partial quantity of preparation to be dispensed from the dosing device (10). The invention further relates to a method of dosing such preparations.

The invention relates to a dosing device according to the preamble of claim 1 for small-particled pharmaceutical preparations, particularly for preparations in the form of pellets, granulates or extruded materials. The invention further relates to a method according to the preamble of claim 17 for dosing small-particled pharmaceutical preparations of this kind and a method according to the preamble of claim 18 for dosing and adjusting the mixing ratio of at least two small-particled pharmaceutical preparations to be taken together.

Finely divided formulations of pharmaceutical preparations such as pellets, granules or extruded preparations have certain advantages over single unit forms such as tablets, including the fact that on the one hand the small-particled preparations are more uniformly distributed in the intestinal tract, which is particularly important in the case of delayed-released forms, and on the other hand are easier to swallow when administered as individual particles. Moreover, a single formulation can cover a wide dosage range, with different quantities packed or administered in corresponding capsules.

Usually, small-particled pharmaceutical preparations of this kind are packed into capsules made of hard gelatin, but these have a number of disadvantages compared with bulk goods, i.e. the small-particled pharmaceutical preparations. For example, the water content of hard gelatin capsules must be greater than or equal to 10% as otherwise the hard gelatin capsules might become brittle, with the result that they would break inside the packaging or when removed from the packaging. With moisture-sensitive preparations this may lead to considerable stability problems, frequently resulting in a short shelf life.

As the correlation between the amount of preparation and the capsule shell is different for different doses, a separate laborious stability test has to be carried out for each dosage.

It is only possible to combine a number of small-particled preparations to a limited extent as the different dosages, i.e. the mixing ratio between the individual preparations, is already fixed in advance. A conventional combined preparation of two active substances wherein the individual components are present in two or three doses requires six fixed drug combinations, for example.

It is known from the prior art to measure a larger quantity of small-grained pharmaceutical preparation into a given partial quantity, using metering devices, and this is then given to the patients, for example.

Thus, U.S. Pat. No. 4,805,811 and EP-0 787 979 A1 each disclose a metering device with a chamber for accommodating a larger quantity of small-grained pharmaceutical preparation. A rotary slide is provided on the metering device, on which a plurality of metering chambers with given capacities are formed. By rotating the metering slide, one metering chamber is filled with a partial quantity of the preparation contained in the chamber, in succession, and is emptied again as the metering slide is rotated further. Different dosages are obtained by removing a corresponding number of partial quantities from the chamber using the rotary slide.

The intention of these known metering or dosing devices is in particular to enable older people and children or those who have difficulty swallowing larger tablets to measure out and take metered quantities of small-particled preparations which are easy to swallow.

A metering or dosing device is known from EP-0 217 390 A2, FR-2 380 536 and FR-2 380 537 which is fitted with a chamber filled with a small-particled pharmaceutical preparation, from which a defined constant quantity of the preparation can be removed from the chamber with the aid of a dosing chamber or dosing coil formed on a slide.

Moreover, from U.S. Pat. No. 4,273,254, GB 1 316 174, U.S. Pat. No. 4,237,884, WO 95/25050 or U.S. Pat. No. 5,255,786, so-called tablet separators are known in which a number of tablets are accommodated in a chamber and can be taken out of the chamber singly with the aid of a slide.

GB 1 511 107 describes a measuring and metering device for metering granular alloys or metal, in which the volume of a metering chamber can be adjusted to suit a specified partial quantity. For this purpose, a pusher is movable in a dosing slide and can be adjusted into set positions by means of a wedge-shaped can. Similar metering devices are known from GB 215 577 and GB 139 342.

Starting from this prior art the invention sets out to provide a dosing device or a method of dosing, preferably self-dosing, small-particled pharmaceutical preparations, with which it is possible to achieve a patient-oriented, individually and smoothly adjustable accurate dosing of a small-particled pharmaceutical preparation or preparations.

This objective is achieved with a dosing device having the features according to claim 1. Moreover, in order to solve the problem, claim 15 recites the use of the dosing device. Furthermore, the problem is solved by a method having the features of claim 17 and a method having the features of claim 18.

The invention is based on the basic idea of carrying out exact dosing of the preparation using the dosing chamber itself and not, as has previously been the norm, by repeatedly filling and emptying a relatively small dosing chamber. For this purpose it is proposed according to the invention to make the dosing chamber variable so as to be able to vary the volume of the dosing chamber and hence the partial quantity dependent on the volume of the dosing chamber which is taken from the larger quantity of preparation contained in the chamber.

Thanks to the to invention it is possible to carry out patient-oriented individual adjustment of the doses, for example when dosing the preparation in relation to the bodyweight, or when adapting the dose to daily requirements. Moreover, the dose of preparation can be individually adjusted over a lengthy period of use, so that preparations which have to be taken in larger doses in the initial phase, for example, can be reduced in controlled manner over the period of the medication. Similarly, patients can increase initial doses gradually up to the dose required therapeutically in order to improve their tolerance. This flexibility of dosing is of particular advantage in children as a wide range of dosage strengths is needed on account of the wide range of bodyweights from a few kilos up to about 70 kilos. Suitable embodiments of the dosing device according to the invention enable pharmaceutical preparations to be dosed e.g. in the range from 40-800 mg or 0.4-8 g, preferably 50-750 mg, or 0.5-7.5 g.

Further advantages of the invention will become apparent from the following description, subsidiary claims and drawings.

Thus, according to a particularly preferred embodiment of the dosing device according to the invention, the volume of the metering chamber can be smoothly adjusted. In this way it is possible to achieve very accurate dosing of the preparation or preparations in order to be able to vary the doses continuously, e.g. over a lengthy medication period, and prescribe a very precise amount per day.

Alternatively, the volume may also be adjusted smoothly by sub-dividing the volume of the metering chamber into equal or different partial volumes. This is advantageous for example when the same dose of preparation is to be taken over a longer period but the dosing device is to be used by different people.

To enable dosing to be carried out, in a particularly preferred embodiment of the dosing device according to the invention, it is proposed to provide a pusher on the dosing element which is mounted to be movable on the dosing element and the head of which is movable back and forth within the dosing chamber in order to vary its volume.

In order to move the pusher, according to a further feature of this embodiment, a threaded spindle is provided by means of which the position of the pusher can be adjusted. The threaded spindle allows the volume of the dosing chamber to be varied smoothly from the outside without any great difficulty. Furthermore it is possible by providing a scale on the dosing element to indicate the position of the pusher on the outside, to enable very accurate dosing of the preparation with a high repetition rate. The scale may for example indicate a correlation between bodyweight and the dose of preparation.

In an alternative embodiment of the dosing device according to the invention it is proposed to provide a latching device on the dosing element by means of which the pusher can be latched in different positions on the dosing element. In this way it is possible to achieve graduated and very accurate adjustment of the dose of preparation with high reproducibility.

Moreover, in another alternative embodiment, for graduated adjustment of the volume of the dosing chamber it is proposed to attach volume inserts of different external dimensions releasably within the dosing chamber in order to adjust the volume. Thus, in order to vary the volume of the dosing chamber, the particular volume insert specified in a dosing table, for example, simply has to be inserted in the dosing chamber. The use of volume inserts of this kind is particularly advantageous when the dose of preparation has to be taken over a lengthy period, which means that the patient need only use one volume insert associated with the required dose. The use of different colours and/or suitable markings for the volume inserts makes it easy even for elderly patients to distinguish between the different volume inserts.

To make it easier to operate the metering device it is further proposed that the dosing element be mechanically biased into its filling position and be movable into its dispensing position counter to this biasing force. This ensures that as soon as the dosing element has dispensed the preparation and been released it returns to its filling position. This prevents, among other things, the preparation contained in the chamber of the dosing device from being contaminated from outside, as the dosing device is closed off to the outside when the dosing element is in the filling position.

In a particularly preferred embodiment of the dosing device according to the invention, it is proposed to use as the dosing element a dosing slide on which the dosing chamber is formed and which is movable in a channel between its filling position and its dispensing position. Alternatively the use of a rotary slide as dosing element is proposed, this slide being rotatable in a receptacle between its filling position and its dispensing position. Both the dosing slide which is movable along a channel and the rotary slide are easily operated, which means that the dosing device according to the invention can also be used without any difficulty by older or frail patients.

It is also possible, for safety reasons, to provide a childproof lock on the dosing device to prevent undesirable operation of the dosing slide or rotary slide, in particular, by children.

The dosing chamber is preferably constructed as a through-opening, in the dosing slide or rotary slide, one open end of which is aligned with an outlet opening of the chamber in the filling position while the other end is aligned with a dispensing opening in the dispensing position, the open ends being closed off in the intermediate positions of the slide by the base and by a plate on the bottom of the base. This design of the dosing chamber as a through-opening ensures that the dosing chamber is properly filled in the filling position and totally emptied in the dispensing position.

In a particularly preferred embodiment of the dosing device according to the invention, a storage container which contains the pharmaceutical preparation can be releasably fixed to the dosing device, this storage container filling the chamber of the dosing device with the preparation. The use of a separate storage container has the advantage that during storage the bulk goods can be packaged in sealed packaging—if appropriate with dry stoppers—under absolutely dry conditions, i.e. stability problems caused by damp are ruled out. The dosing device is not fitted onto the storage container until the drug is started, so that the further stability of the preparation only needs to be guaranteed for the period of use (ranging from some days to a few weeks). If there is an interruption in taking the drug, the dosing device can be replaced by the stopper once more, thereby forming a sealed pack. Furthermore, stability testing on the bulk goods has only to be carried out for the maximum period of use of the dosing device, i.e. for the lowest dose.

Frequently, a plurality of small-particled preparations are combined with one another and packed into a hard gel capsule, while the preparations must be present in a defined mixing ratio produced by the dosing of the preparations. However, problems of compatibility may arise in combinations of this kind. Thus, in combined preparations, only fixed combinations are possible, i.e. if for example preparations A and B of a combination are administered in three doses each, there are nine possible fixed combinations. With specific combinations of preparations, however, it is desirable to have only a few possible fixed combinations, which means that problems may arise in dosing.

In order to be able to dose a plurality of preparations which are combined with one another, in a particularly preferred embodiment of the dosing device according to the invention it is proposed that at least one additional chamber be provided on the dosing device for accommodating another small-particled pharmaceutical preparation, a partial quantity of the additional preparation being dispensed through the dispensing opening of said additional chamber. In this way it is possible to dose different preparations individually in one operation, corresponding to the number of additional chambers, and mix them together in the correct ratio.

In this embodiment of the dosing device according to the invention it is further proposed to provide an additional dosing chamber on the dosing element for the additional preparation, which is connected to a chamber opening of the additional chamber in the filling position for filling with the additional preparation and which is connected to the dispensing opening in the dispensing position or in an intermediate position of the dosing element for dispensing the additional preparation. In this way the preparations are dosed and mixed together by a single movement of the dosing element. Alternatively, it is also possible to provide a separate dosing element for each chamber.

The material used to produce the dosing device according to the invention is preferably a plastics material which can be used to produce thin-walled injection moulded components. Particularly preferred are plastics from which no plasticizers leach out. In special cases it may be convenient to use a plastics material which can be autoclaved.

In another aspect, the invention relates to a method according to claim 15 for dosing small-particled pharmaceutical preparations, particularly preparations in the form of pellets, granulated or extruded materials. The dosing may be carried out by the users themselves, e.g. the patient, doctor or pharmacist, immediately before the preparation is taken. In the process according to the invention, a larger quantity of the preparation is prepared in one chamber and then a defined partial amount of the preparation is transferred from the chamber into a dosing chamber of a specified volume, the volume of the dosing chamber, which determines the partial amount to be dispensed, being preselected before being filled with the preparation. The partial quantity thus measured off is then discharged from the dosing chamber.

In a third aspect the invention relates to another process as defined in claim 16 for dosing a plurality of preparations, wherein the mixing ratio between the preparations is set at the same time as the dosing takes place. As in the method described above, in this process, a larger amount of each preparation is stored in each of a number of separate chambers and then a predetermined partial amount of the particular preparation is removed by means of a dosing chamber of adjustable volume.

The invention will hereinafter be described in more detail by means of a preferred embodiment with reference to the accompanying drawings, wherein:

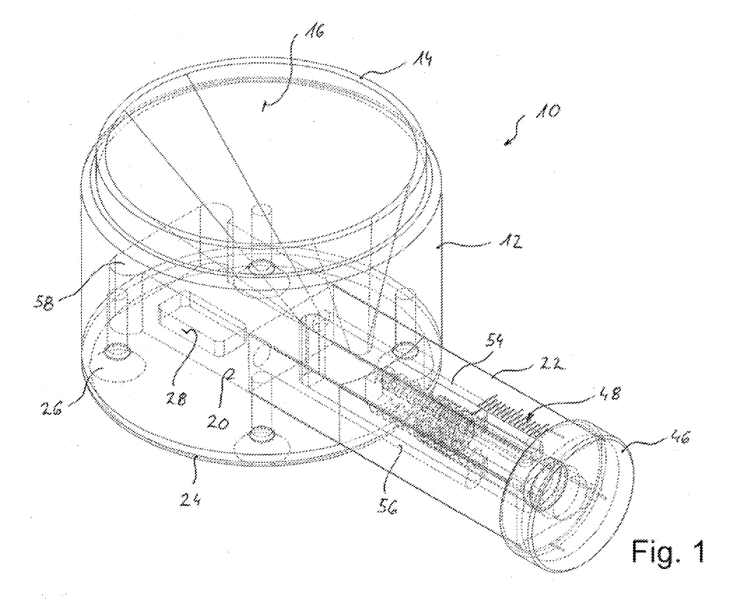

FIG. 1 is a perspective view of a dosing device according to the invention for dispensing a defined partial amount of a small-particled pharmaceutical preparation;

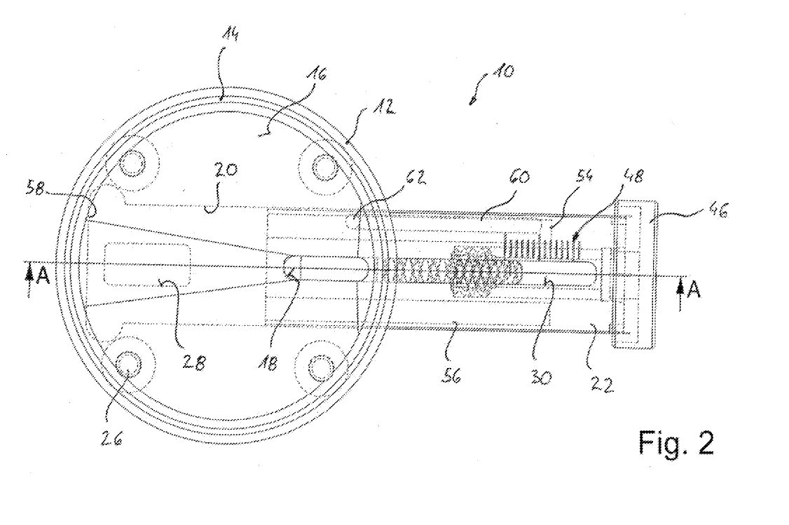

FIG. 2 is a plan view of the dosing device according to the invention as shown in FIG. 1; and

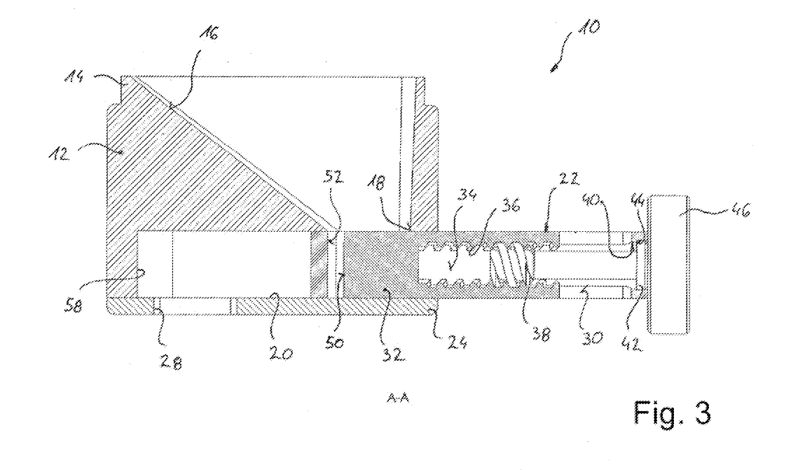

FIG. 3 is a section through the dosing device according to the invention along the section A-A in FIG. 2.

FIGS. 1 to 3 show a dosing device 10 according to the invention for dispensing a defined partial amount of a small-particled pharmaceutical preparation. The dosing device 10 has a substantially cylindrical base 12 in the form of an injection moulded plastics part. Protruding from the top of the base 12 is an encircling flange 14 extended axially in the direction of the axis of symmetry of the base 12. A storage container (not shown) for the pharmaceutical preparation with its container opening can be releasably placed over the encircling flange 14.

As shown in the sectional view in FIG. 3, there is formed in the base 12, starting from its top, a chamber 16 which tapers in a funnel shape asymmetrically with respect to the axis of symmetry of the base 12 towards the bottom of the base 12. The asymmetrically tapering chamber 16 merges into an oblong hole 18 which opens into a channel 20 extending at right angles to the axis of symmetry of the base 12 and this channel is also formed on the base 12. The asymmetric configuration of the chamber 16 ensures that the oblong hole 18 extends at a small radial spacing from the wall of the base 12, as shown in FIG. 3, the oblong hole 18 running parallel, in its longitudinal direction, to the longitudinal direction of the channel 20.

Inserted in the channel 20 is a dosing slide 22 of substantially rectangular cross-section which is movable back and forth in the longitudinal direction of the channel 20. A round plate 24 is also secured to the bottom of the base 12 by means of screws 26 (shown by broken dotted lines in FIGS. 1 and 2). In the plate 24 is formed a rectangular dispensing opening 28 the longitudinal direction of which extends in the longitudinal direction of the channel 20 and is aligned therewith. The plate 24 is screwed to the base 12 so that the smallest radial spacing of the dispensing opening 28 from the outer surface of the base 12 corresponds substantially to the smallest radial spacing of the oblong hole 18 from the outer surface of the base 12, but the dispensing opening 28 and the oblong hole 18 are arranged close to the opposite ends of the channel 20.

As shown in FIGS. 2 and 3, in particular, there is formed in the dosing slide 22, in the longitudinal direction thereof, a slot 30 which extends substantially over the entire length of the dosing slide 22 but is closed at its ends. The dosing slide 22 is inserted in the channel 20 so that the slot 30 is partially covered at its open upper side by the bottom of the base 12 and, at its open underside, by the top of the plate 24. A pusher 32 is movably accommodated in slot 30, this pusher being provided at its end facing the base 12 with a threaded bore 34 having a helical thread 36.

A threaded spindle 38 extending in the longitudinal direction of the dosing slide 22 is screwed into the helical thread 36 and this threaded spindle projects through a mounting orifice 40 from the end of the dosing slide 22 protruding from the channel 20. Level with the mounting orifice 40 is provided, on the threaded spindle 38, an encircling mounting flange 42 to which the threaded spindle 38 is axially secured in a groove 44 formed in the mounting orifice 40. Attached to the free end of the threaded spindle 38 is a knurled screw 46 by means of which the threaded spindle 38 can be rotated back and forth by hand about its longitudinal axis. Four notches (visible in FIG. 1) are formed on the inner diameter of the knurled screw 46. These notches engage on a corner of the dosing slide 22. The other three corners of the dosing slide are flattened in this area. In this way the knurled screw 46 engages in 90° increments. With a spindle having a pitch of 4 mm, this results in an adjustability graduated in 1 mm increments. The position of the pusher 32 in the slot 30 can be read off by means of a scale 48 provided on the top of the dosing slide 22 (c.f. FIGS. 1 and 2).

By rotating the knurled screw 36 the pusher 32 can be moved back and forth in the longitudinal direction within the slot 30, the head 50 of the pusher forming a dosing chamber 52 at the end face of the pusher 32 with the wall of the slot 30, the volume of this chamber thus being capable of being smoothly adjusted by means of the pusher 32, as will be described in detail.

On both sides of the slot 30 are formed, parallel to said slot in the dosing slide 22, two cylindrical bores 54 and 56 which extend in the direction of the mounting orifice 40, starting from their end face inserted in the channel 20. Each bore 54 and 56 accommodates, in the finished assembled state of the dosing device 10, a compression spring (not shown), these compression springs bearing on the wall of a pocket 58 formed at the end opposite the insertion end of the channel 20.

As shown moreover by broken lines in the plan view of the dosing device 10 in FIG. 2, on the underside of the dosing slide 22 is formed a groove 60 which also extends in the longitudinal direction of said slide, in which a pin 62 protruding from the other side of the plate 24 is received. With the aid of the pin 62 the longitudinal movement of the dosing slide 22 in the channel 20 is limited; the dosing slide 22 can only be forced outwards by the compression springs (not shown) to the point where the dosing slide 22 is abutting, under spring bias, on the pin 62, as shown in FIG. 2. In this so-called filling position the dosing slide 22 with its dosing chamber 52 is situated directly below the oblong hole 18 of the chamber 16.

If the dosing slide 22 is pressed manually into the channel 20 counter to the force of the compression springs, the pin 62 limits the movement of the dosing slide 22 into the channel 20 such that the dosing slide 22 with its dosing chamber 52 is situated above the dispensing opening 28 in the so-called dispensing position. In the intermediate positions between the filling position and the dispensing position the dosing chamber 52 is closed off by the bottom of the base 12 and by the top of the plate 24.

In order to use the dosing device 10 according to the invention, first of all the position of the pusher 32 in the slot 30 is adjusted using the knurled screw 46 and the scale 48, thereby adjusting the volume of the dosing chamber 52. The volume is adjusted, for example, as a function of bodyweight, which is indicated on the scale 48 as a unit of measurement. Once the volume of the dosing chamber 52 has been adjusted the dosing device 10 is fitted over the opening of the open storage container (not shown) by means of the flange 14 in the upside-down position, i.e. with the plate 24 facing upwards.

Then the dosing device 10 is rotated together with the storage container, so that part of the small-particled pharmaceutical preparation contained in the storage container falls into the chamber 16. A partial amount of the preparation then falls through the oblong hole 18 into the dosing chamber 52, while the preselected volume of the dosing chamber 52 determines the partial amount of the preparation. After the dosing chamber 52 has been filled the dosing slide 22 is moved counter to the force of the compression springs (not shown) from its filling position into the dispensing position in which the dosing chamber 52 is aligned with the dispensing opening 28. As a result the partial quantity of the pharmaceutical preparation contained in the dosing chamber 52 drops out of the dosing chamber 52 through the dispensing opening 28, for example, into a container provided by the user. After the preparation has been dispensed the dosing slide 22 is released by the user, so that the dosing slide 22 can return to its filling position by the action of the compression springs.

The user can then repeat the removal process in accordance with the given dosages and periods of medication, possibly until the storage container is totally empty.

Alternatively, the user has the option of removing the dosing device 10 from the storage container and sealing the storage container in the conventional manner.

The dosing device 10 shown in FIGS. 1 to 3 is simply one possible embodiment of the dosing device according to the invention. Theoretically, however, all kinds of embodiments and further features of this principle illustrated in FIGS. 1 to 3 are possible.

Thus, for example, it is possible to replace the flange 16 by an internal thread with seal into which a storage container sealed by means of a screw cap can be screwed using its external thread. Moreover, for certain storage containers a coupling device may be provided on the dosing device 10, onto which the storage container is fitted, while for example a spike provided on the coupling device penetrates a membrane which seals off the storage container, to enable the preparation contained in the storage container to enter the dosing device 10. Alternatively, it is also possible to integrate the dosing device 10 in a storage container so that the dosing device 10 is integrally formed with the storage container.

Instead of the pusher 32 which is to be adjusted smoothly by means of a threaded spindle 38, it is also possible to provide a latching device with which the pusher 32 can be latched in prescribed latching positions in the slot 30. Moreover, a dosing slide 22 may be used in which is formed a dosing chamber with a fixed preset volume, volume inserts being releasably secured in the dosing chamber by latching therein in order to vary the volume.

It is also possible to lock the dosing slide 22 by means of latching means such as latching lugs in the various positions, such as the filling position, the dispensing position or an intermediate position, in order to ensure, for example, proper filling or emptying of the dosing chamber 52. Locking the dosing slide 22 in the release position or an intermediate position is particularly advantageous when the volume of the dosing chamber 52 is to be adjusted with the storage container placed thereon.

The storage container is preferably made from an easily processed plastics material which can be worked by injection moulding, for example. Furthermore, the material should be adapted to be autoclaved so that it can be sterilised if necessary.

In a particularly preferred embodiment of the dosing device according to the invention, two chambers are formed for two different preparations, so that a combined preparation can be made up with the individual components being separately dosed.

As the dispenser according to the invention can be refilled using refill packs after the entire dose has been administered, this is a cost saving for long term therapy as the costs of individual capsules no longer arise. By the suitable use of leak tight packaging means, optionally with desiccants, the shelf life can be substantially improved.

### LIST OF REFERENCE NUMERALS

| | |
|---|---|
| 10 | Dosing device |
| 12 | Base |
| 14 | Flange |
| 16 | Chamber |
| 18 | Oblong hole |
| 20 | Channel |
| 22 | Dosing slide |
| 24 | Plate |
| 26 | Screws |
| 28 | Dispensing opening |
| 30 | Slot |
| 32 | Pusher |
| 34 | Threaded bore |
| 36 | Helical thread |
| 38 | Threaded spindle |
| 40 | Mounting orifice |
| 42 | Mounting flange |
| 44 | Groove |
| 46 | Knurled screw |
| 48 | Scale |
| 50 | Head of pusher |
| 52 | Dosing chamber |
| 54 | Cylindrical bore |
| 56 | Cylindrical bore |
| 58 | Pocket |
| 60 | Groove |
| 62 | Pin |

1. Device for dosing small-particled pharmaceutical preparations, which comprises a chamber (16) for accommodating a larger amount of the preparation and a dosing element with a dosing chamber (52) for accommodating a defined partial amount of the preparation, the dosing chamber being movable between a filling position, in which it is to be filled with preparation from the chamber (16), and a dispensing position in which the preparation from the dosing chamber (52) is to be discharged from the dosing device, characterized in that the volume of the dosing chamber (52) is adjustable in order to set the defined partial quantity of preparation to be dispensed from the dosing device.

2. Dosing device according to claim 1, characterized in that the volume of the dosing chamber (52) can be adjusted smoothly or stepwise.

3. Dosing device according to claim 1, characterized in that movably mounted on the dosing element is a pusher (32), the head (50) of which is movable back and forth in the dosing chamber (52) in order to vary the volume thereof.

4. Dosing device according to claim 3, characterized in that a threaded spindle (38) by means of which the position of the pusher (32) can be varied is provided on the dosing element.

5. Dosing device according to claim 4, characterized in that the pusher can be latched in various positions on the dosing element by means of a latching device.

6. Dosing device according to claim 1, characterized in that volume inserts with different external dimensions are releasably fixable in the dosing chamber in order to vary the volume.

7. Dosing device according to claim 1, characterized in that the dosing element is a dosing slide (22) which is movable in the channel (20) between its filling position and its dispensing position.

8. Dosing device according to claim 1, characterized in that the dosing slide (22) is preferably biased into its filling position by a compression spring and is movable into its dispensing position counter to the biasing force.

9. Dosing device according to claim 1, characterized in that the dosing element is a rotary slide which is rotatable in a receptacle between its filling position and its dispensing position.

10. Dosing device according to claim 1, characterized in that the dosing chamber (52) provided on the dosing slide (22) or rotary slide is in the form of a through-opening, one open end of which is aligned with an outlet opening (18) of the chamber (16) in the filling position while the other open end thereof is aligned with a dispensing opening (28) in the dispensing position, the open ends being sealed off by the base (12) and the plate (24) in the intermediate positions of the slide.

11. Dosing device according to claim 1, characterized in that a storage container containing the pharmaceutical preparation is releasably fixable to the dosing device, said storage container filling the chamber (16) with the preparation.

12. Dosing device according to claim 1, characterized in that at least one further chamber is provided for accommodating an additional small-particled pharmaceutical preparation, from which a partial quantity of the additional preparation is to be dispensed through the dispensing opening.

13. Dosing device according to claim 12, characterized in that a further dosing chamber is provided on the dosing element, which is connected with a chamber opening of the further chamber in the filling position for filling with the additional preparation and is connected to the dispensing opening in the dispensing position or an intermediate position of the dosing element in order to dispense the additional preparation.

14. Dosing device according to claim 1, characterized in that the dosing device is made from a plastics material and is preferably constructed as an injection molded part, the plastics material optionally being suitable for autoclaving.

15-16. (canceled)

17. Method of dosing, particularly self-dosing, small-particled pharmaceutical preparations, particularly preparations in the form of pellets, granules or extruded materials, by the user immediately before taking the preparation, wherein
a larger quantity of the preparation is stored in a chamber (16),
a defined partial quantity of the preparation is transferred from the chamber (16) into a dosing chamber (52) of a given volume, the volume of the dosing chamber (52) determining the partial quantity to be transferred, and
the partial quantity of the preparation contained in the dosing chamber (52) is dispensed ready for taking,
characterized in that the volume of the dosing chamber (52) before being filled with the preparation is adjusted in order to preset the partial amount to be dispensed.

18. Method of dosing, particularly self-dosing, and adjusting the mixing ratio between two small-particled pharmaceutical preparations to be taken together, particularly preparations in the form of pellets, granules or extruded materials, by the user immediately before the preparations are taken, wherein
in each case a larger quantity of each of the two preparations is placed in readiness in a separate chamber,
from each chamber a defined partial quantity of the particular preparation is dispensed into a dosing chamber assigned to the preparation, the volume of the particular dosing chamber defining the partial quantity of the preparation which is to be dispensed, and
the two partial quantities of the two preparations are dispensed ready for taking,
characterized in that
the volume of at least one of the dosing chambers is adjusted before the dispensing of the preparations in order to measure out the amount and adjust the mixing ratio.
